(19) United States
(12) Patent Application Publication
(10) Pub. No.: US 2010/0309070 A1
(43) Pub. Date: Dec. 9, 2010

(54) MULTIBAND SINGLE-STRIP MONOPOLE ANTENNA

(75) Inventors: Kin-Lu Wong, Hsichih (TW); Shu-Chuan Chen, Hsichih (TW)

Correspondence Address: Wang Law Firm, Inc., 4989 Peachtree Parkway,, Suite 200, Norcross, GA, 30092, US

(73) Assignee: ACER INCORPORATED, Hsichih (TW)

(21) Appl. No.: 12/561,226

(22) Filed: Sep. 16, 2009

(30) Foreign Application Priority Data
Jun. 6, 2009 (TW) 098118975

(51) Int. Cl. H01Q 1/38; H01Q 9/00; H01Q 1/48

(52) U.S. Cl. 343/749; 343/700 MS; 343/843; 343/848

(57) ABSTRACT

A multiband single-strip monopole antenna includes a dielectric substrate, a ground plane, and a radiating portion. The ground plane is disposed on one surface of the dielectric substrate without completely covering the surface of the dielectric substrate. The radiating portion is disposed on the surface of the dielectric substrate without overlapping the ground plane, and is internally embedded with an inductive element, via which a continuous path through the inductive element is formed between a start point and an open end of the radiating portion. Since the inductive element can compensate for an increased capacitive reactance caused by a reduced antenna length, good antenna matching can still be achieved even when the size of the antenna is reduced.

### FIELD OF THE INVENTION

The present invention relates to a multiband single-strip monopole antenna, and more particularly to a miniaturized multiband monopole antenna suitable for use with a portable communication device.

### BACKGROUND OF THE INVENTION

Following the prosperous development in wireless communication, various kinds of wireless communication techniques and products have been developed and improved. Among others, portable communication devices are the most welcome communication products among consumers. While the portable communication devices are designed to have a compact body but versatile functions, the space in the portable communication devices available for mounting the antenna is greatly reduced at the same time. As a result, all kinds of antenna miniaturization technique have been constantly developed in response to the increasing market demands for portable communication devices. The multiband antenna design for most of the currently available portable communication devices is achieved by adopting multiple resonant paths or two resonant paths. For example, Taiwan Patent Publication No. 541759 discloses a folder-type dual-band monopole antenna, which uses two resonant paths to implement dual-band or multiband operation. However, the use of two resonant paths or multiple resonant paths will limit the miniaturization of the antenna, making it difficult to be embedded inside the limited space in the modern multiband portable communication devices.

### SUMMARY OF THE INVENTION

A primary object of the present invention is to provide a multiband single-strip monopole antenna applicable to the mobile communication device, which uses one single resonant path to achieve multiband operation and can therefore enable further reduction in antenna size while meets the wireless communication requirement for covering multiband operation in the GSM850/900/1800/1900/UMTS bands

To achieve the above and other objects, the antenna according to the present invention includes a dielectric substrate, a ground plane, and a radiating portion. The ground plane is disposed on one surface of the dielectric substrate without completely covering the surface of the dielectric substrate. The radiating portion is disposed on the surface of the dielectric substrate without overlapping the ground plane, and is internally embedded with an inductive element, via which a continuous path through the inductive element is formed between a start point and an open end of the radiating portion. The radiating portion includes a first metal section and a second metal section. The first metal has an end forming the start point of the radiating portion and electrically connected to a signal source, and another end electrically connected to the inductive element; and the first metal section has a length about one-quarter wavelength of a center frequency of the antenna in a high-frequency operating mode. The second metal section has an end electrically connected to the inductive element and another end forming the open end of the radiating portion; and a total length of the first and the second metal sections is shorter than one-fifth wavelength of a center frequency of the antenna in a low-frequency operating mode. The first and the second metal section each can have uniform width or varying widths in shape. The inductive element can be a lumped or a distributed inductive element. The ground plane, the first metal section, the second metal section, and the distributed inductive element can be formed on the surface of the dielectric substrate through printing or etching process.

The antenna according to the present invention is a monopole antenna internally embedded an inductive element. By properly adjusting the position and the inductance value of the inductive element, it is able to achieve an antenna structure for covering multiband operation in the GSM850/900/1800/1900/UMTS bands to meet the nowadays wireless communication requirement for multiband operation. Further, unlike conventional antennas that must have a length about one-quarter wavelength thereof, the antenna of the present invention has an overall length shorter than one-fifth wavelength of a center frequency of the antenna in a low-frequency operating mode, and can therefore be further reduced in size. As it is known, an inductive element would have an electric characteristic similar to a short circuit at low frequency and an electric characteristic similar to an open circuit at high frequency. By taking advantage of these characteristics of the inductive element, the present invention disposes an inductive element inside a monopole antenna with a distance between the inductive element and a feed point of the antenna being about one-quarter wavelength of a center frequency of the antenna in a high-frequency operating mode at about 1900 MHz, and this distance is also the length of the first metal section of the radiating portion of the antenna. The antenna of the present invention can have an overall length, i.e. a total length of the first and the second metal section, shorter than one-fifth wavelength of a center frequency of the antenna in a low-frequency operating mode at about 900 MHz. Since the inductive element can compensate for the increased capacitive reactance caused by the reduced antenna length, good antenna matching can still be achieved even when the antenna is reduced in size.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an antenna according to a first embodiment of the present invention.

FIG. 2 is a chart showing the return loss measurements obtained from an experiment conducted on the antenna according to the first embodiment of the present invention.

FIG. 3 is a perspective view of an antenna according to a second embodiment of the present invention.

FIG. 4 is a perspective view of an antenna according to a third embodiment of the present invention.

### DETAILED DESCRIPTION OF THE PREFERRED EMBODIMENTS

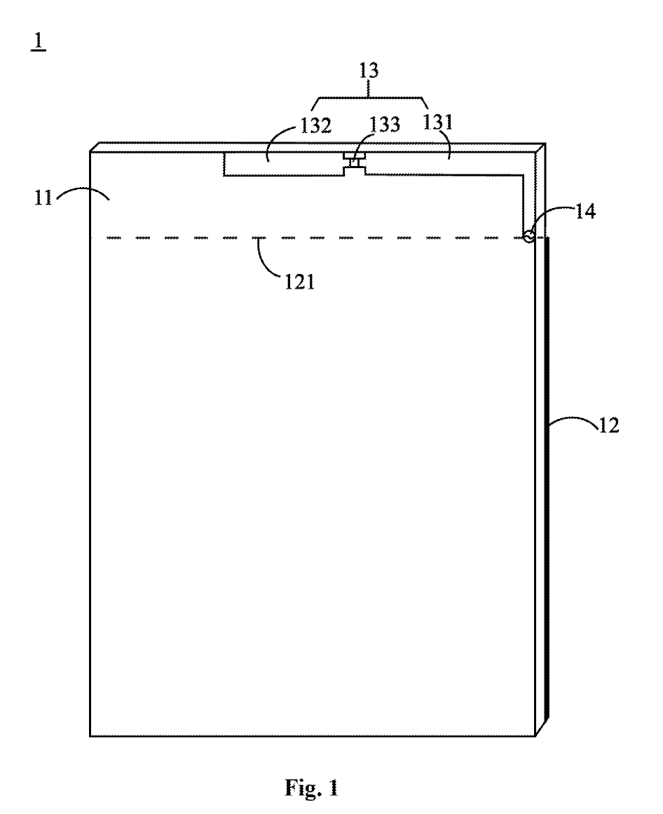

Please refer to FIG. 1 which is a perspective view of a multiband single-strip monopole antenna 1 according to a first embodiment of the present invention. As shown, the antenna 1 includes a dielectric substrate 11, a ground plane 12 disposed on one surface of the dielectric substrate 11, and a radiating portion 13 disposed on one surface of the dielectric substrate 11 without overlapping the ground plane 12. The dash line 121 shows the edge of the ground plane 12. Within the radiating portion 13, there is provided a lumped inductive element 133. Via the lumped inductive element 133, a continuous path is formed between a start point and an open end of the radiating portion 13. The radiating portion 13 includes a first metal section 131 and a second metal section 132. The first metal section 131 has an end forming the start point of the radiating portion 13 and electrically connected to a signal source 14, and another end electrically connected to the lumped inductive element 133. The first metal section 131 has an overall length about one-quarter wavelength of a center frequency of the antenna in a high-frequency operating mode. The second metal section 132 has an end electrically connected to the lumped inductive element 133 and another end forming the open end of the radiating portion 13. A total length of the first and the second metal sections 131, 132 is shorter than one-fifth wavelength of a center frequency of the antenna in a low-frequency operating mode. The dielectric substrate 11 may be a system circuit board for a mobile communication device. The first metal section 131 and the second metal section 132 may be formed on the dielectric substrate 11 through a printing process or an etching process.

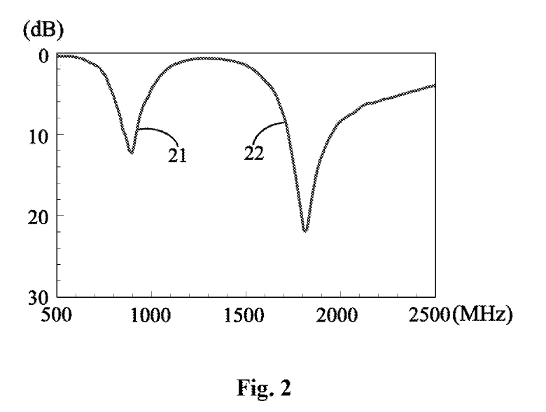

FIG. 2 is a chart showing the return loss measurements obtained from an experiment conducted on the antenna according to the first embodiment of the present invention. With the antenna 1 used in the experiment, the dielectric substrate 11 is about 115 mm in length and about 60 mm in width; the ground plane 12 is about 100 mm in length and about 60 mm in width; and the radiating portion 13 is internally embedded with a lumped inductive element 133 having an inductance value about 15 nH, and includes a first metal section 131 about 37 mm in length and about 7 mm in width as well as a second metal section 132 about 17 mm in length and about 7 mm in width. According to the results from the experiment, under the definition of 6 dB return loss, a first (low-frequency) operating band 21 of the antenna 1 is sufficient to cover both GSM850 and GSM900 bands, and a second (high-frequency) operating band 22 is sufficient to cover the GSM1800, GSM1900 and UMTS bands. Therefore, the antenna of the present invention meets the nowadays wireless communication requirement for covering multiband operation in the GSM850/900/1800/1900/UMTS bands.

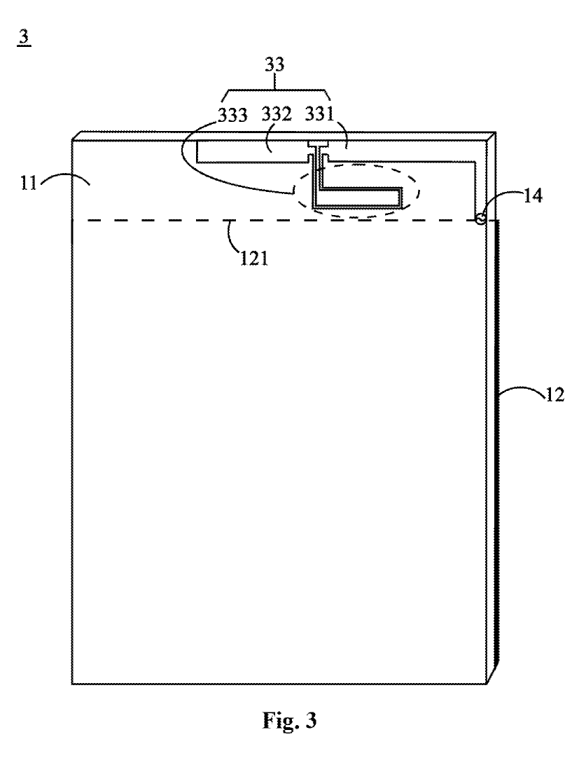

FIG. 3 is a perspective view of an antenna 3 according to a second embodiment of the present invention. The antenna 3 in the second embodiment is generally structurally similar to the antenna 1 in the first embodiment, except for a radiating portion 33 that is internally embedded with a distributed inductive element 333. Via the distributed inductive element 333, a continuous path is formed between a start point and an open end of the radiating portion 33. The radiating portion 33 includes a first metal section 331 and a second metal section 332. The antenna 3 in the second embodiment is different from the antenna 1 in the first embodiment in that the distributed inductive element 333 is formed on dielectric substrate 11 through printing or etching process, allowing the antenna 3 to be manufactured with a further simplified and cost-effective process while meets the nowadays wireless communication requirement for covering multiband operation in the GSM850/900/1800/1900/UMTS bands.

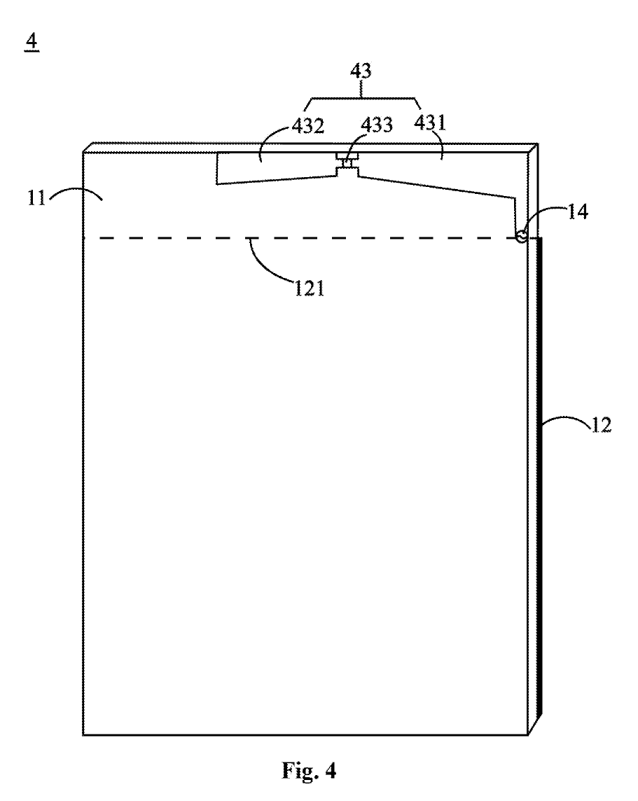

FIG. 4 is a perspective view of an antenna 4 according to a third embodiment of the present invention. The antenna 4 has a radiating portion 43 internally embedded with a lumped inductive element 433. Via the lumped inductive element 433, a continuous path is formed between a start point and an open end of the radiating portion 43. The radiating portion 43 includes a first metal section 431 and a second metal section 432. The antenna 4 in the third embodiment is generally structurally similar to the antenna 1 in the first embodiment, except that the first and the second metal sections 431, 432 of the radiating portion 43 each have gradually varied width to thereby form a varying-width structure. The change in the width of the metal sections 431, 432 can be used to adjust antenna matching, so as to fine adjust the antenna's high-frequency mode and low-frequency mode to effectively cover the multiband operation in the GSM850/900/1800/1900/UMTS bands as required by nowadays wireless communication.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multiband single-strip monopole antenna comprising:
a dielectric substrate;
a ground plane disposed on one surface of the dielectric substrate without completely covering the surface of the dielectric substrate; and
a radiating portion disposed on one surface of the dielectric substrate without overlapping the ground plane; the radiating portion being internally embedded with an inductive element, via which a continuous path being formed between a start point and an open end of the radiating portion; the radiating portion including:
a first metal section having an end forming the start point of the radiating portion and electrically connected to a signal source, and another end electrically connected to the inductive element; and the first metal section having a length about one-quarter wavelength of a center frequency of the antenna in a high-frequency operating mode; and
a second metal section having an end electrically connected to the inductive element and another end forming the open end of the radiating portion; and a total length of the first and the second metal section being short than one-fifth wavelength of a center frequency of the antenna in a low-frequency operating mode.

2. The multiband single-strip monopole antenna as claimed in claim 1, wherein the dielectric substrate is a system circuit board for a mobile communication device.

3. The multiband single-strip monopole antenna as claimed in claim 1, wherein the first metal section and the second metal section are formed on the dielectric substrate through a printing process or an etching process.

4. The multiband single-strip monopole antenna as claimed in claim 1, wherein the inductive element is a lumped inductive element.

5. The multiband single-strip monopole antenna as claimed in claim 1, wherein the inductive element is a distributed inductive element.

6. The multiband single-strip monopole antenna as claimed in claim 5, wherein the distributed inductive element is formed on the dielectric substrate through a printing process or an etching process.
